(19) United States
(12) Patent Application Publication
(10) Pub. No.: US 2025/0313342 A1
(43) Pub. Date: Oct. 9, 2025

(54) AIRCRAFT COMPRISING AT LEAST ONE PROPULSION ASSEMBLY COMPRISING AT LEAST ONE MOTORIZATION AND A TRANSMISSION SYSTEM CONNECTED BY AN EXTERNAL COUPLING SYSTEM

(71) Applicant: Airbus Operations SAS, TOULOUSE (FR)

(72) Inventors: Franck ALVAREZ, TOULOUSE (FR); Thomas SPIGOLON, BLAGNAC (FR); Vincent MARTY, BLAGNAC (FR)

(21) Appl. No.: 19/090,802

(22) Filed: Mar. 26, 2025

(30) Foreign Application Priority Data
Apr. 4, 2024 (FR) FR2403459

(51) Int. Cl. B64D 35/021; B64D 27/34

(52) U.S. Cl. CPC B64D 35/021; B64D 27/34

(57) ABSTRACT

An aircraft comprising at least one propulsion assembly comprising: at least one electric motor, a transmission system, at least one coupling module comprising a freewheel inserted between inner and outer shafts coupled by first and second coupling mechanisms to the output and input shafts of the electric motor and of the transmission system, at least one of the first and second coupling mechanisms comprising an angle gearset, at least one hollow intermediate element in which the output shaft of the electric motor, the input shaft of the transmission system and the inner and outer tubes of the coupling module are at least partially positioned.

### CROSS-REFERENCES TO RELATED APPLICATIONS

This application claims the benefit of French Patent Application Number FR2403459 filed on Apr. 4, 2024, the entire disclosure of which is incorporated herein by way of reference.

### FIELD OF THE INVENTION

The present application relates to a propulsion assembly comprising at least one motorization and a transmission system connected by an external coupling system and also relates to an aircraft comprising such a propulsion assembly.

### BACKGROUND OF THE INVENTION

According to one embodiment seen in FIG. 1, an aircraft 10 comprises a fuselage 12, at least one wing 14 connected to the fuselage 12 and propulsion assemblies 16 connected to the wing 14 and arranged on either side of the fuselage 12. As illustrated in FIGS. 2 and 3, each propulsion assembly 16 comprises a propeller 18 which has an axis of rotation A18.

In the following description, a longitudinal direction is parallel to the axis of rotation A18 of the propeller 18. The terms ‘front’ and ‘rear’ refer to the direction of airflow relative to the aircraft in flight, with air flowing longitudinally from front to rear.

An electric propulsion assembly comprises a plurality of electric motors 20 and a transmission system 22, such as a gearbox, configured to couple the electric motors 20 to the propeller 18.

As shown in FIG. 3, the transmission system 22 comprises a first casing 24 which has, in the longitudinal direction, a front wall F24 facing the propeller 18 and a rear wall F24′ to which the electric motors 20 are attached, as well as at least one drive train 26, positioned in the first casing 24, which has at least one input 28 for each electric motor 20 and an output 30, in the form of an output shaft, passing through the front wall F24 to be coupled to the propeller 18.

Each electric motor 20 has a second casing 32 which comprises a bearing face F32 fixed against the rear wall F24′ of the first casing 24, as well as an output shaft 34, projecting with respect to the bearing face F32, passing through the rear wall F24′ of the first casing 24. This output shaft 34 is coupled to one of the inputs 28 of the drive train 26 of the transmission system 22 by a coupling system 36 positioned in the first casing 24 of the transmission system 22.

According to one embodiment, each coupling system 36 comprises a freewheel configured to occupy a coupled state in which the output shaft 34 of the corresponding electric motor 20 is coupled in rotation and transmits a rotational movement to the drive train 26 of the transmission system 22, as well as an uncoupled state, in the event of an incident, for example, in which the output shaft 34 of the corresponding electric motor 20 is no longer coupled to the drive train 26 of the transmission system 22 and no longer transmits any rotational movement thereto.

In this way, if an electric motor 20 is no longer operating and its output shaft 34 is blocked against rotation, the coupling system 36 allows it to be isolated from the drive train 26, which remains operational and transmits the rotational movements of the other electric motors 20 to the propeller 18.

The coupling systems 36 require more frequent maintenance than the other elements of the transmission system 22. For each of them, the transmission system 22 must be removed, which involves disassembling the electric motors 20, and its casing 24 must be opened in order to access the coupling systems 36. These different stages are relatively long, tedious and costly.

To overcome this disadvantage, document FR3139554 proposes a propulsion assembly 16 which has an offset coupling system 36′. According to one embodiment of this document seen in FIG. 4, each electric motor 20 has an output shaft 34′ positioned on a rear face of the electric motor 20 opposite to its front face connected to the transmission system 22. This output shaft 34′ is hollow and configured to house the coupling system 36′. It also comprises:
a freewheel 36.1′ having a first part connected to the output shaft 34′ of the electric motor 20 and a second part,
a coupling shaft 36.2′ passing through the electric motor 20 and connecting the second part of the freewheel 36.1′ and the input 28′ of the transmission system 22.

As the coupling system 36′ is offset from the transmission system 22 and located on the rear face of the electric motor 20, it is accessible such that it is no longer necessary to remove the transmission system and disassemble it in order to carry out a maintenance operation on the coupling system.

However, this solution is not optimal because the coupling system 36′ comprises a coupling shaft 36.2′ which passes through the electric motor 20, requiring the latter to be modified.

The present invention aims to overcome some or all of the disadvantages of the prior art.

### SUMMARY OF THE INVENTION

To this effect the subject of the invention is a propulsion assembly comprising at least one electric motor which has an output shaft and a pivot axis, a transmission system which has an input shaft and a second pivot axis, as well as at least one coupling module connecting the output shaft of the electric motor and the input shaft of the transmission system; the coupling module comprising inner and outer shafts which are coaxial, spaced apart and each have a first end and a common third pivot axis, as well as a freewheel inserted between the inner and outer shafts.

According to the invention, the propulsion assembly comprises at least one hollow intermediate element in which the output shaft of the electric motor, the input shaft of the transmission system and the inner and outer tubes of the coupling module are at least partially positioned, a first coupling mechanism connecting the inner shaft and a first element from the output shaft of the electric motor and the input shaft of the transmission system, as well as a second coupling mechanism connecting the outer shaft, and a second element, different from the first element, from the output shaft of the electric motor and the input shaft of the transmission system, at least one of the first and second coupling mechanisms comprising an angle gearset.

This solution can be implemented without modification inside the electric motor and transmission system and makes it possible to disassemble or replace the coupling module quickly and simply without needing to disassemble the electric motor and/or the transmission system, which saves time in maintaining said coupling module.

According to another feature, the coupling module comprises a casing configured to house the inner and outer shafts and the freewheel as well as a releasable connection connecting said casing and the hollow intermediate element.

According to one feature, the casing comprises:
a tubular body which extends between first and second ends, the first end being open and oriented towards the hollow intermediate element,
a cover configured to close off the second end and connected to the body by a releasable connection.

According to another feature, the coupling module comprises at least one rotation guide system connecting the outer shaft and the third casing, and a set of stops for immobilizing the outer shaft and the third casing relative to each other in translation in a direction parallel to the third pivot axis.

According to another feature, the coupling module comprises at least one blocking element for immobilizing in translation, in a direction parallel to the third pivot axis, the inner shaft and the first element from the output shaft of the electric motor and the input shaft of the transmission system to which the inner shaft is coupled.

According to another feature, the third pivot axis of the coupling module and the first or second pivot axis of the first element from the output shaft and the input shaft to which the inner shaft is coupled are aligned. In addition, the first coupling mechanism is configured to immobilize the inner shaft and the first element from the output shaft and the input shaft against rotation relative to each other.

According to another feature, the first element from the output shaft of the electric motor and the input shaft of the transmission system to which the inner shaft is coupled comprises a housing configured to house the first end of the inner shaft.

According to another feature, the inner shaft is hollow. In addition, the blocking element is an assembly screw which comprises a head bearing against the inner shaft, as well as a shank housed in the inner tube, the shank having a threaded end configured to screw into a tapped hole provided in the housing of the first element from the output shaft and the input shaft to which the inner shaft is coupled.

According to another feature, the third pivot axis of the coupling module is perpendicular to the first and second pivot axes of the output shaft of the electric motor and of the input shaft of the transmission system. In addition, the first coupling mechanism comprises a first angle gearset which comprises a first bevel gear attached to the first end of the inner shaft and a second bevel gear attached to the first element from the output shaft of the electric motor and the input shaft of the transmission system to which the inner shaft is coupled, the first and second bevel gears being configured to cooperate and mesh with each other.

According to another feature, the blocking element is a stop inserted between, on the one hand, the third casing and, on the other hand, the inner shaft and/or the first bevel gear attached to the inner shaft, said stop being configured to immobilize the inner shaft relative to the third casing so that the first and second bevel gears cooperate with each other.

According to another feature, the second coupling mechanism comprises a second angle gearset which comprises a first bevel gear attached to the outer shaft as well as a second bevel gear attached to the second element from the output shaft of the electric motor and the input shaft of the transmission system to which the outer shaft is coupled, the first and second bevel gears being configured to cooperate and mesh with each other.

According to a first variant, the hollow intermediate element is separate from the electric motor and the transmission system.

According to another variant, the hollow intermediate element forms a single part with the electric motor or the transmission system.

The subject of the invention is also an aircraft comprising at least one propulsion assembly according to one of the preceding features.

### BRIEF DESCRIPTION OF THE DRAWINGS

Further features and advantages will emerge from the following description of the invention, provided as an example only, with reference to the enclosed drawings, in which:

FIG. 1 is a side view of an aircraft,

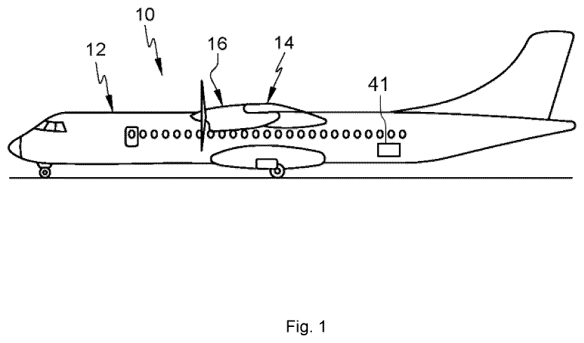

FIG. 2 is a schematic side view of an electric propulsion assembly showing an embodiment of the prior art,

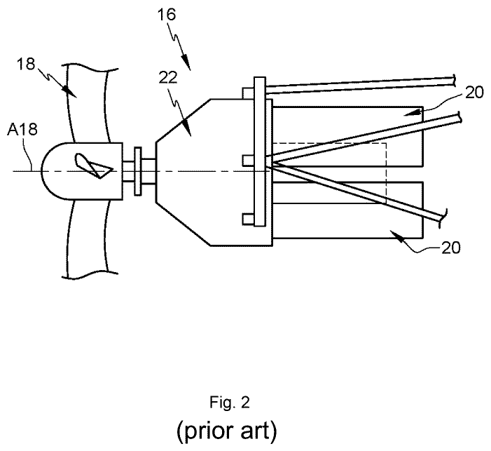

FIG. 3 is a schematic cross-section of a transmission system and of the electric motors of a propulsion assembly showing an embodiment of the prior art,

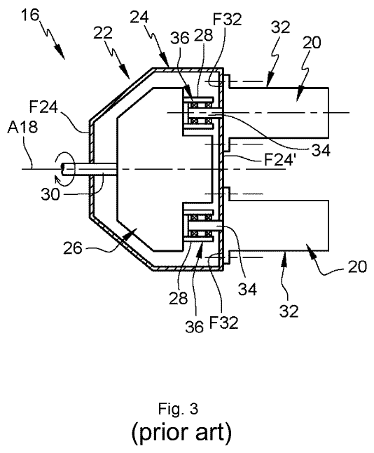

FIG. 4 is a schematic cross-section of a transmission system and of the electric motors of a propulsion assembly showing another embodiment of the prior art,

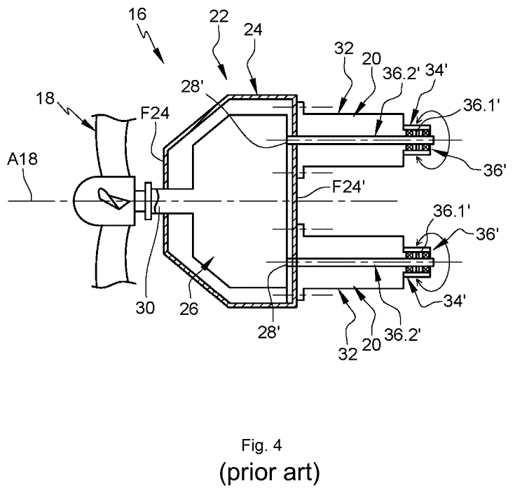

FIG. 5 is a schematic cross-section of an electric motor and of a transmission system connected by a coupling module showing an embodiment of the invention, the coupling module being in the assembled state,

FIG. 6 is a schematic cross-section of an electric motor and of a transmission system connected by a coupling module showing an embodiment of the invention, the coupling module being in the disassembled state,

FIG. 7 is a schematic cross-section of an electric motor and of a transmission system connected by a coupling module showing another embodiment of the invention,

FIG. 8 is a schematic cross-section of an electric motor and of a transmission system connected by a coupling module showing another embodiment of the invention,

FIG. 9 is a schematic cross-section of an electric motor and of a transmission system connected by a coupling module showing another embodiment of the invention.

### DETAILED DESCRIPTION OF THE PREFERRED EMBODIMENTS

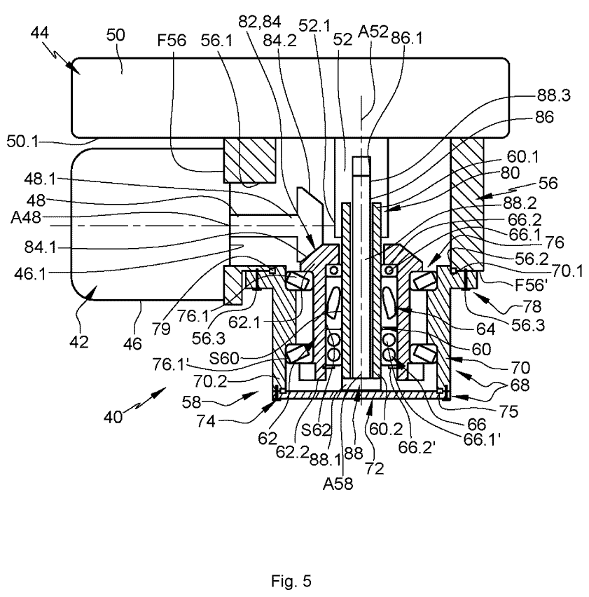

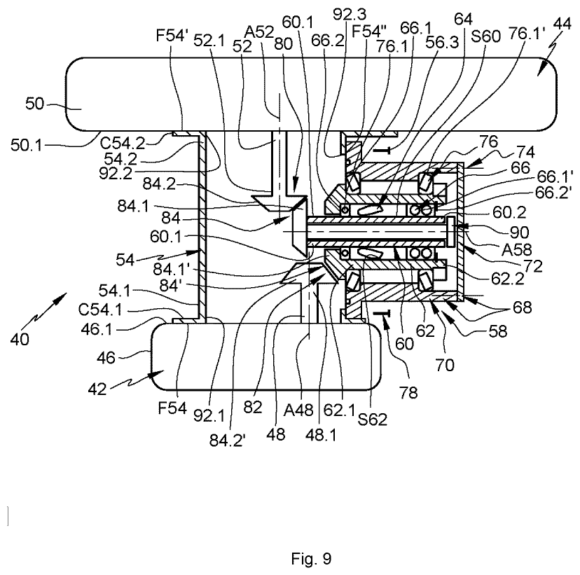

According to an embodiment seen in FIGS. 5 and 9, an electric propulsion assembly 40 comprises at least one electric motor 42 and a transmission system 44, such as a gearbox, configured to couple the electric motor 42 to a propulsion system, such as a propeller. The at least one electric motor 42 is electrically powered by at least one fuel cell 41 on board the aircraft, for example in the fuselage 12 of the aircraft, in the wing 14 or in the propulsion assembly 40.

According to one application, an aircraft comprises at least one such propulsion assembly 40. Of course, the invention is not limited to this application.

Each electric motor 42 comprises a first casing 46, which has a first front face 46.1, and an output shaft 48, which has a first pivot axis A48, connected to the first casing 46 by a pivot connection projecting from the first front face 46.1. According to one arrangement, the first front face 46.1 is substantially perpendicular to the first pivot axis A48. The output shaft 48 has a free end 48.1 spaced apart from the first front face 46.1.

Each transmission system 44 comprises a second casing 50, which has a second front face 50.1, and an input shaft 52, which has a second pivot axis A52, connected to the second casing 50 by a pivot connection projecting from the second front face 50.1. According to one arrangement, the second front face 50.1 is substantially perpendicular to the second pivot axis A52. The input shaft 52 has a free end 52.1 spaced apart from the second front face 50.1.

The electric motor 42 and the transmission system 44 are immobile relative to each other.

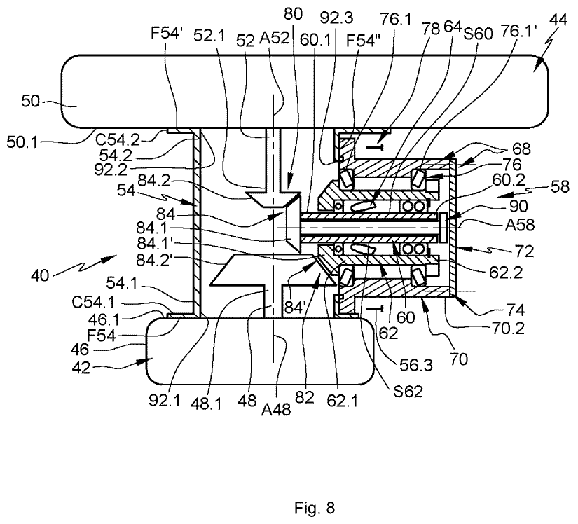

According to a first arrangement seen in FIGS. 8 and 9, the electric motor 42 and the transmission system 44 are connected by fasteners to a single hollow intermediate support 54 separate from the electric motor 42 and the transmission system 44. According to one embodiment, the first and second pivot axes A48, A52 are substantially parallel to each other. In addition, the hollow intermediate support 54 is a cylindrical tube which has an axis substantially parallel to the first and second pivot axes A48, A52 and extends between first and second open ends 54.1, 54.2, which are respectively provided with first and second flanges C54.1, C54.2, the electric motor 42 being connected to the first flange C54.1 and the transmission system 44 being connected to the second flange C54.2. According to this embodiment, the output shaft 48 of the electric motor 42 and the input shaft 52 of the transmission system 44 are positioned inside the hollow intermediate support 54.

According to a second arrangement seen in FIGS. 5 to 7, the electric motor 42 and the transmission system 44 are directly connected to each other. According to one embodiment, the transmission system 44 comprises a hollow extension 56 which has an opening 56.1 to allow the passage of the output shaft 48 of the electric motor 42, the electric motor 42 being located outside the hollow extension 56 and connected to the hollow extension 56 around the lateral opening 56.1. According to this embodiment, the output shaft 48 of the electric motor 42 and the input shaft 52 of the transmission system 44 are positioned inside the hollow extension 56.

Of course, the invention is not limited to these arrangements. Whatever the arrangement, the propulsion assembly 40 comprises a hollow intermediate element, such as the hollow intermediate support 54 or the hollow extension 56, attached to the electric motor 42 and the transmission system 44, and in which the output shaft 48 of the electric motor 42 and the input shaft 52 of the transmission system 44 are at least partially positioned.

According to certain embodiments seen in FIGS. 8 and 9, the hollow intermediate element is separate from the electric motor 42 and the transmission system 44.

According to other embodiments seen in FIGS. 5 to 7, the hollow intermediate element forms a single part with the electric motor 42 or the transmission system 44.

The propulsion assembly 40 comprises at least one coupling module 58 connecting the output shaft 48 of the electric motor 42 and the input shaft 52 of the transmission system 44. Each coupling module 58 comprises coaxial, spaced apart inner and outer shafts 60, 62, as well as a freewheel 64 inserted between the inner and outer shafts 60, 62 and connecting them, said freewheel 64 being configured to occupy a coupled state in which a first shaft from the inner and outer shafts 60, 62 is coupled in rotation and transmits a rotational movement to a second shaft different from the first shaft from the inner and outer shafts 60, 62, as well as an uncoupled state, in the event of an incident for example, in which the first shaft is no longer coupled to the second shaft and no longer transmits a rotational movement thereto. The coupling module 58 has a third pivot axis A58 coincident with the pivot axes of the inner and outer shafts 60, 62. Each of the inner and outer shafts 60, 62 comprises a first end 60.1, 62.1 facing the electric motor 42 and/or the transmission system 44 and a second end 60.2, 62.2 opposite to the first end 60.1, 62.1. The outer shaft 62 is hollow to house the inner shaft 60 and the freewheel 64.

According to one embodiment, the coupling module 58 comprises at least one first rotation guide system 66 connecting the inner and outer shafts 60, 62 and allowing them to pivot relative to each other about the third pivot axis A58. According to one configuration, the first rotation guide system 66 comprises at least two rolling bearings 66.1, 66.1′ positioned on either side of the freewheel 64. The coupling module 58 comprises a pair of stops 66.2, 66.2′, positioned on either side of the rolling bearings 66.1, 66.1′, to immobilize the first guide system 66 and the freewheel 64 in translation in a direction parallel to the third pivot axis A58 with respect to the outer shaft 62.

According to one embodiment, the inner shaft 60 has an outer surface S60 which comprises an inner track of the freewheel 64 and/or the outer shaft 62 has an inner surface S62 which comprises an outer track of the freewheel 64.

According to one configuration, the coupling module 58 comprises a third casing 68 configured to house the inner and outer shafts 60, 62 and the freewheel 64. This third casing 68 comprises a tubular and cylindrical body 70 which extends between first and second ends 70.1, 70.2, the first end 70.1 being open and oriented towards the hollow intermediate element 54, 56.

According to one configuration, the second end 70.2 is sealed off to protect the inner and outer shafts 60, 62 and the freewheel 64. According to one embodiment, the third casing 68 comprises a cover 72 configured to seal off the second end 70.2, said cover 72 being connected to the body 70 by a releasable connection 74 such as a plurality of fasteners distributed around the periphery of the cover 72. According to one arrangement, the coupling module 58 comprises at least one seal 75 inserted between the body 70 and the cover 72 to provide a sealed connection between these two elements.

According to one embodiment, the coupling module 58 comprises at least one second rotation guide system 76 connecting the outer shaft 62 and the third casing 68, which is positioned between the outer shaft 62 and the body 70 and allows them to pivot relative to each other about the third pivot axis A58. According to one configuration, the second rotation guide system comprises two rolling bearings 76.1, 76.1′ positioned near the first and second ends 70.1, 70.2 of the body 70. The coupling module 58 comprises a first pair of stops positioned on either side of the rolling bearings 76.1, 76.1′ to immobilize the second guide system 76 in translation in a direction parallel to the third pivot axis A58 with respect to the outer shaft 62, as well as a second pair of stops positioned between the rolling bearings 76.1, 76.1′ to immobilize the second guide system 76 in translation in a direction parallel to the third pivot axis A58 with respect to the third casing 68. Generally, the coupling module 58 comprises a set of stops for immobilizing the outer shaft 62 and the third casing 68 relative to each other in translation in a direction parallel to the third pivot axis A58.

According to one arrangement, the coupling module 58 and more particularly its third casing 68 is connected to the hollow intermediate element 54, 56 by a releasable connection 78. According to one embodiment, the first end 70.1 of the body 70 is connected to the hollow intermediate element 54, 56 by the releasable connection 78, which comprises a plurality of fasteners distributed around the circumference of the first end 70.1. According to one arrangement, the coupling module 58 comprises at least one seal 79 inserted between the third housing 68 and the hollow intermediate element 54, 56 to obtain a sealed connection between these two elements.

Of course, the invention is not limited to these embodiments for the coupling module 58. Whatever the embodiment, the propulsion assembly 40 comprises at least one hollow intermediate element 54, 56 in which the output shaft 48 of the electric motor 42, the input shaft 52 of the transmission system 44 and the inner and outer shafts 60, 62 of the coupling module 58 are at least partially positioned such that they cooperate with the output and input shafts 48, 52 of the electric motor 42 and of the transmission system 44.

The propulsion assembly 40 comprises a first coupling mechanism 80 connecting the inner shaft 60 and a first element from the output shaft 48 of the electric motor 42 and the input shaft 52 of the transmission system 44, as well as a second coupling mechanism 82 connecting the outer shaft 62 and a second element, different from the first element, from the output shaft 48 of the electric motor 42 and the input shaft 52 of the transmission system 44.

According to a particular feature of the invention, the third pivot axis A58 of the coupling module 58 intersects at least one of the first and second pivot axes A48, A52. In addition, at least one of the first and second coupling mechanisms 80, 82 comprises an angle gearset 84.

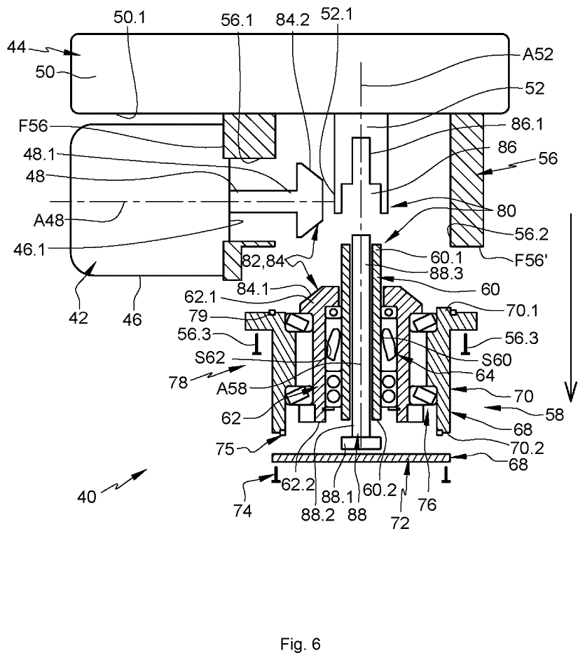

According to a first embodiment seen in FIGS. 5 and 6, the third pivot axis A58 of the coupling module 58 is perpendicular to the first pivot axis A48 of the output shaft 48 of the electric motor 42 and aligned with the second pivot axis A52 of the input shaft 52 of the transmission system 44. According to this first embodiment, the first coupling mechanism 80 connects the inner shaft 60 of the coupling module 58 and the input shaft 52 of the transmission system 44. At its free end 52.1, this input shaft 52 comprises a housing 86 configured to house the first end 60.1 of the inner shaft 60. The first coupling mechanism 80 allows the inner shaft 60 to rotate the input shaft 52. According to one configuration, the housing 86 of the input shaft 52 and the first end 60.1 of the inner shaft 60 respectively comprise female and male splines configured to cooperate with each other and allow the input shaft 52 to be driven in rotation by the inner shaft 60.

According to this first embodiment, the inner shaft 60 is hollow. The coupling module 58 comprises at least one blocking element 88 for immobilizing in translation, in a direction parallel to the third pivot axis A58, the inner shaft 60 and the first element from the output shaft 48 of the electric motor 42 and the input shaft 52 of the transmission system 44 to which the inner shaft 60 is coupled. According to one configuration, this blocking element 88 is an assembly screw which comprises a head 88.1 bearing against the second end 60.2 of the inner shaft 60, as well as a shank 88.2 housed in the inner tube 60 and having a threaded end 88.3 configured to screw into a tapped hole 86.1 provided in the housing 86 of the input shaft 52 of the transmission system 44. This assembly screw allows the inner shaft 60 and the input shaft 52 to be immobilized in translation in a direction parallel to the second pivot axis A52.

According to this first embodiment, the first coupling mechanism 80 comprises a first part, such as the male and female splines, to immobilize the inner shaft 60 and the outer shaft 62 in rotation relative to each other, as well as a second part, such as the assembly screw, to immobilize the inner shaft 60 and the input shaft 52 in translation. Of course, the invention is not limited to this embodiment. Thus, the first coupling mechanism 80 may comprise a single means, such as a transverse pin, for immobilizing the inner shaft 60 and the input shaft 52 in rotation and translation relative to each other.

According to this first embodiment, the second coupling mechanism 82 comprises an angle gearset 84 which comprises a first bevel gear 84.1, such as a crown wheel, attached to the first end 62.1 of the outer shaft 62, as well as a second bevel gear 84.2, such as a bevel pinion, attached to the output shaft 48 of the electric motor 42, the first and second bevel gears 84.1, 84.2 being configured to cooperate and mesh with each other.

According to this first embodiment, the transmission system 44 comprises a hollow extension 56 which has at least one first face F56 substantially parallel to the second pivot axis A52 of the input shaft 52 of the transmission system 44, in which a first opening 56.1 is provided, as well as a second face F56′ substantially perpendicular to the second pivot axis A52 of the input shaft 52 of the transmission system 44, in which a second opening 56.2 is provided, the first face F56 being positioned between the second casing 50 of the transmission system 44 and the second face F56′ of the hollow extension 56. In addition, the first casing 46 of the electric motor 42 is connected to the hollow extension 56 around the first opening 56.1, the output shaft 48 of the electric motor 42 passing through the first opening 56.1. The third casing 68 of the coupling module 58 is connected to the hollow extension 56, around the second opening 56.2, by means of fasteners 56.3 of the releasable connection 78.

As shown in FIG. 6, the coupling module 58 is disassembled as follows:

Firstly, the cover 72 is removed by removing the fasteners of the releasable connection 74.

Next, the blocking element 88 and the fasteners 56.3 of the releasable connection 78 are removed.

The coupling module 58 can then be removed.

The coupling module 58 is reassembled in the reverse order, replacing the seals 75, 79 if necessary.

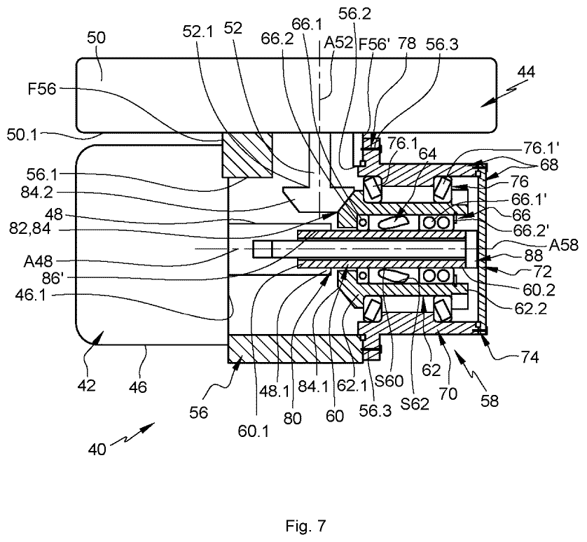

According to a second embodiment seen in FIG. 7, the third pivot axis A58 of the coupling module 58 is aligned with the first pivot axis A48 of the output shaft 48 of the electric motor and substantially perpendicular to the second pivot axis A52 of the input shaft 52 of the transmission system 44. According to this second embodiment, the first coupling mechanism 80 connects the inner shaft 60 of the coupling module 58 and the output shaft 48 of the electric motor 42. At its free end 48.1, this output shaft 48 comprises a housing 86′ configured to house the first end 60.1 of the inner shaft 60. It may be identical to that shown in FIGS. 5 and 6 connecting the inner shaft 60 and the input shaft 52 of the transmission system 44.

According to this second embodiment, the second coupling mechanism 82 comprises an angle gearset 84 which comprises a first bevel gear 84.1, such as a bevel crown wheel, attached to the first end 62.1 of the outer shaft 62, as well as a second bevel gear 84.2, such as a bevel pinion, attached to the input shaft 52 of the transmission system 44, the first and second bevel gears 84.1, 84.2 being configured to cooperate and mesh with each other.

According to this second embodiment, the transmission system 44 comprises a hollow extension 56 which has at least one first face F56 substantially parallel to the second pivot axis A52 of the input shaft 52 of the transmission system 44, in which a first opening 56.1 is provided, as well as a second face F56′ substantially parallel to the second pivot axis A52 of the input shaft 52 of the transmission system 44, in which a second opening 56.2 is provided. In addition, the first casing 46 of the electric motor 42 is connected to the hollow extension 56, the output shaft 48 of the electric motor 42 passing through the first opening 56.1. The third casing 68 of the coupling module 58 is connected to the hollow extension 56, around the second opening 56.2, by means of fasteners 56.3 of the releasable connection 78.

According to a third embodiment seen in FIG. 8, the electric motor 42 and the transmission system 44 are arranged such that the first and second pivot axes A48, A52 are substantially parallel to each other and aligned. In addition, the third pivot axis A58 of the coupling module 58 is substantially perpendicular to the first and second pivot axes A48, A52 of the output and input shafts 48, 52 of the electric motor 42 and of the transmission system 44. According to this third embodiment, the first coupling mechanism 80 comprises a first angle gearset 84 which comprises a first bevel gear 84.1 attached to the first end 60.1 of the inner shaft 60, as well as a second bevel gear 84.2 attached to the input shaft 52 of the transmission system 44, the first and second bevel gears 84.1, 84.2 being configured to cooperate and mesh with each other. In addition, the second coupling mechanism 82 comprises a second angle gearset 84′ which comprises a first bevel gear 84.1′ attached to the first end 62.1 of the outer shaft 62, as well as a second bevel gear 84.2′ attached to the output shaft 48 of the electric motor 42, the first and second bevel gears 84.1′, 84.2′ being configured to cooperate and mesh with each other.

According to the third embodiment, the coupling module 58 comprises at least one blocking element 90 for immobilizing in translation, in a direction parallel to the third pivot axis A58, the inner shaft 60 and the first element from the output shaft 48 of the electric motor 42 and the input shaft 52 of the transmission system 44 to which the inner shaft 60 is coupled. According to one configuration, this blocking element 90 is a stop inserted between the third casing 68, more particularly its cover 72, and the inner shaft 60 and/or the first bevel gear 84.1 attached to the first end 60.1 of the inner shaft 60. This stop is configured to immobilize the inner shaft 60 with respect to the third casing 68 so that the first and second bevel gears 84.1, 84.2, respectively attached to the inner shaft 60 and the input shaft 52 of the transmission 44, cooperate with each other.

According to this third embodiment, the propulsion assembly 40 comprises a hollow intermediate support 54 which has at least one first face F54 substantially perpendicular to the first pivot axis A48 of the output shaft 48 of the electric motor 42, in which a first opening 92.1 is provided, a second face F54′ substantially parallel to the first face F54 and perpendicular to the second pivot axis A52 of the input shaft 52 of the transmission system 44, in which a second opening 92.2 is provided, and a third face F54″ substantially perpendicular to the first and second faces F54, F54′ and situated between them, and in which a third opening 92.3 is provided. In addition, the first casing 46 of the electric motor 42 is connected to the hollow intermediate support 54 around the first opening 92.1, the output shaft 48 of the electric motor 42 passing through the first opening 92.1. The second casing 50 of the transmission system 44 is connected to the hollow intermediate support 54 around the second opening 92.3, the input shaft 52 of the transmission system 44 passing through the second opening 92.2. The third casing 68 of the coupling module 58 is connected to the hollow intermediate support 54, around the third opening 92.3, by means of fasteners distributed around the third opening 92.3.

According to a fourth embodiment seen in FIG. 8, the electric motor 42 and the transmission system 44 are arranged such that the first and second pivot axes A48, A52 are substantially parallel to each other and offset from each other. The other elements of the coupling module 58 may be identical to those in the third embodiment.

In the third and fourth embodiments, the coupling module 58 is removed by removing the fasteners that connect the third casing 68 of the coupling module 58 and the hollow intermediate support 54.

Whatever the embodiment, it is possible to disassemble or replace the coupling module 58 quickly and simply without needing to disassemble the electric motor 42 and/or the transmission system 44, which saves time in maintaining said coupling module 58.

According to another advantage, the propulsion assembly 40 comprises an electric motor 42 and/or a transmission system 44 without any modification inside the first and second casings 46, 50 compared with those of the prior art.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claim is:

1. An aircraft comprising:
at least one propulsion assembly comprising:
a propulsion propeller,
at least one electric motor which has an output shaft and a pivot axis,
at least one fuel cell supplying electricity to the at least one electric motor,
a transmission system configured to couple the at least one electric motor to the propulsion propeller, the transmission system having an input shaft and a second pivot axis,
at least one coupling module connecting the output shaft of the at least one electric motor and the input shaft of the transmission system, the coupling module comprising inner and outer shafts which are coaxial, spaced apart, and each have a first end and a common third pivot axis, as well as a freewheel inserted between the inner and outer shafts,
at least one hollow intermediate element in which the output shaft of the at least one electric motor, the input shaft of the transmission system and the inner and outer tubes of the at least one coupling module are at least partially positioned,
a first coupling mechanism connecting the inner shaft and a first element from the output shaft of the at least one electric motor and the input shaft of the transmission system, and,
a second coupling mechanism connecting the outer shaft and a second element, different from the first element, from the output shaft of the at least one electric motor and the input shaft of the transmission system,
wherein at least one of the first and second coupling mechanisms comprises an angle gearset.

2. The aircraft as claimed in claim 1, wherein the at least one coupling module comprises:
a casing configured to house the inner and outer shafts and the freewheel, and
a releasable connection connecting said casing and the at least one hollow intermediate element.

3. The aircraft as claimed in claim 2, wherein the casing comprises:
a tubular body which extends between first and second ends, the first end being open and oriented towards the at least one hollow intermediate element, and,
a cover configured to close off the second end and connected to the tubular body by a releasable connection.

4. The aircraft as claimed in claim 2, wherein the at least one coupling module comprises:
at least one rotation guide system connecting the outer shaft and the casing, and
a set of stops for immobilizing the outer shaft and the casing relative to each other in translation in a direction parallel to the third pivot axis.

5. The aircraft as claimed in claim 1, wherein the at least one coupling module comprises:
at least one blocking element for immobilizing in translation, in a direction parallel to the third pivot axis, the inner shaft and the first element from the output shaft of the at least one electric motor and the input shaft of the transmission system to which the inner shaft is coupled.

6. The aircraft as claimed in claim 1, wherein the third pivot axis of the at least one coupling module and the first or second pivot axis of the first element from the output shaft and the input shaft to which the inner shaft is coupled are aligned, and
wherein the first coupling mechanism is configured to immobilize the inner shaft and the first element from the output shaft and the input shaft against rotation relative to each other.

7. The aircraft as claimed in claim 6, wherein the first element from the output shaft of the at least electric motor and the input shaft of the transmission system to which the inner shaft is coupled comprises a housing configured to house the first end of the inner shaft.

8. The aircraft as claimed in claim 7, wherein the at least one coupling module comprises:
at least one blocking element for immobilizing in translation, in a direction parallel to the third pivot axis, the inner shaft and the first element from the output shaft of the at least one electric motor and the input shaft of the transmission system to which the inner shaft is coupled,
wherein the inner shaft is hollow, and
wherein the at least one blocking element is an assembly screw which comprises a head bearing against the inner shaft and a shank housed in the inner tube, the shank having a threaded end configured to screw into a tapped hole provided in the housing of the first element from the output shaft and the input shaft to which the inner shaft is coupled.

9. The aircraft as claimed in claim 1, wherein the third pivot axis of the at least one coupling module is perpendicular to the first and second pivot axes of the output shaft of the at least one electric motor and of the input shaft of the transmission system and wherein the first coupling mechanism comprises a first angle gearset which comprises a first bevel gear integral with the first end of the inner shaft and a second bevel gear attached to the first element from the output shaft of the at least one electric motor and the input shaft of the transmission system to which the inner shaft is coupled, the first and second bevel gears being configured to cooperate and mesh with each other.

10. The aircraft as claimed in claim 5, wherein the blocking element is a stop inserted between, on one hand, a casing and, on another hand, the inner shaft, or the first bevel gear attached to the inner shaft, or both,
said stop being configured to immobilize the inner shaft relative to the casing so that the first and second bevel gears cooperate with each other.

11. The aircraft as claimed in claim 1, wherein the second coupling mechanism comprises a second angle gearset which comprises a first bevel gear attached to the outer shaft and a second bevel gear attached to the second element from the output shaft of the at least one electric motor and the input shaft of the transmission system to which the outer shaft is coupled, the first and second bevel gears being configured to cooperate and mesh with each other.

12. The aircraft as claimed in claim 1, wherein the at least one hollow intermediate element is separate from the at least one electric motor and the transmission system.

13. The aircraft as claimed in claim 1, wherein the at least one hollow intermediate element forms a single part with the at least electric motor or the transmission system.
